(19) United States
(12) Patent Application Publication
(10) Pub. No.: US 2026/0101184 A1
(43) Pub. Date: Apr. 9, 2026

(54) METHOD, CONFIGURATION PROGRAM, APPLICATION PROGRAM DATASET, COMPUTER-READABLE DATA CARRIER AS WELL AS SERVER DEVICE FOR PROVIDING ACCESS TO INFORMATION PROVIDED IN SECURITY CREDENTIALS

(71) Applicant: Giesecke+Devrient Mobile Security Germany GmbH, Munchen (DE)

(72) Inventors: Michael Posch, Munich (DE); Hemant Udhavrao Borase, Livermore, CA (US)

(73) Assignee: Giesecke+Devrient Mobile Security Germany GmbH, Munchen (DE)

(21) Appl. No.: 19/351,038

(22) Filed: Oct. 6, 2025

Related U.S. Application Data
(60) Provisional application No. 63/704,240, filed on Oct. 7, 2024.

(51) Int. Cl. H04W 12/06; G06F 9/54

(52) U.S. Cl. CPC H04W 12/06; G06F 9/546

(57) ABSTRACT

Methods and systems are disclosed for configuring a user device. Security credentials are provided to allow a secure element of the user device to enable access to a secured service, for example, at least one mobile telecommunication network. The security credentials are stored in the secure element. An application program dataset is configured to at least partly access and alter information provided in the security credentials via an application programming interface (API).

### CROSS REFERENCE TO RELATED DOCUMENT(S)

This application claims priority to U.S. Provisional Application No. 63/704,240 entitled “Method, Configuration Program, Application Program Dataset, Computer-Readable Data Carrier As Well As Server Device Configured For Accessing Security Credentials” and filed on Oct. 7, 2024, which application is incorporated by reference in its entirety.

### TECHNICAL FIELD

The present disclosure relates to the field of configuring user devices, such as smart cards, transaction cards, personal mobile devices, Internet-of-Things (IoT) devices, or alike, to access certain secured services, for example, for gaining access to mobile telecommunication networks. More specifically, the present disclosure relates to a method of configuring a user device to enable a user to access to a secured service.

### BACKGROUND

User devices, such as personal mobile devices or IoT-devices, as well as smart cards (e.g., so-called java cards), identification cards, transaction cards, etc., are configured to employ electronic subscriber profiles. The profiles authenticate a user for enabling secure operations which may involve a trusted entity. Such secure operations may take place as accesses to restricted areas and/or information, secure transactions, data accesses, communications via telecommunication networks, e.g., mobile networks, etc.

User devices may be equipped with an electronic/embedded secure element (SE, eSE), also known as tamper resistant element (TRE), which may take the form of an UICC, eUICC, iUICC, SIM, eSIM, iSIM, or alike, configured to store certain security credentials, and/or one or more of the electronic subscriber profiles that may allow the user devices to connect to mobile networks. A subscriber profile (e.g., an eSIM profile) may be generated by a mobile network operator (MNO) and may be stored, e.g., downloaded, to a mobile user device. The subscriber profile may then be installed on a secure element of the user device and used for communication over a corresponding mobile network by the user device.

### SUMMARY

The present disclosure is directed to the interaction between the user devices and/or their secure elements when dealing with security credentials. A way is provided to handle security credentials of user devices stored in their secure elements involving multiple parties.

According to an aspect, a method of configuring a user device to enable a user to access to a secured service, in particular for communication via at least one mobile telecommunication network, is provided, the method comprising the steps of providing security credentials, for example, by a trusted entity, adapted to allow a secure element, such as an eUICC, of the user device, to enable access to a secured service, for example, the at least one mobile telecommunication network; storing the security credentials in the secure element; and providing an application program dataset configured to at least partly access and/or alter information provided in the security credentials via an application programming interface (API).

According to an aspect, a configuration program for configuring a user device to enable a user to access to a secured service, in particular for communication via mobile telecommunication networks, is provided, wherein the configuration program comprises instructions which, when the configuration program is executed by a server device, a user device, and/or a secure element, cause the server device, the user device, and/or the secure element to carry out a corresponding method.

According to an aspect, an application program dataset for operating a secure element of a user device, such as an eUICC, is provided, wherein the application program dataset is configured to carry out a corresponding method according to at least one of claims and/or configured with a corresponding configuration program.

According to an aspect, a computer-readable data carrier is provided, having stored thereon a corresponding configuration program and/or a corresponding application program dataset.

According to an aspect, a user device, in particular a mobile device or an IoT device to be configured to enable a user to access to a secured service, such as for communication via a mobile telecommunication network, is provided, wherein the user device is configured to carry out a corresponding method, comprises a corresponding configuration program, a corresponding application program dataset and/or a corresponding computer-readable data carrier.

According to an aspect, a server device is provided, such as a security server providing a secure location for handling security credentials, in particular user profiles, to enable access to a secured service, such as for communication via mobile telecommunication networks, wherein the server device is configured to carry out a corresponding method, comprises a corresponding configuration program, a corresponding application program dataset and/or a corresponding computer-readable data carrier.

The secure element may be understood as any kind of tamper resistant element, such as an UICC, eUICC, iUICC, SIM, eSIM, iSIM, or alike. The security credentials may comprise at least one profile identifier, security key, authentication certificate, cryptographic parameter, or alike, and can contain subscription data required for accessing at least one mobile telecommunication network. A respective set of security credentials can be provided for accessing the mobile telecommunication network.

Access to certain information provided in the security credentials can be provided. The application program dataset can access and/or alter respective information through the API. Alternatively, or additionally, the API may be configured to access and/or alter a pre-defined secure storage location of the secure element, such as a particular memory region containing, adapted or at least intended to contain a security credential, such as a security key, or alike. The security credentials or at least their respective functionality can thus be made available to the operating system, for example, in order to initiate a registration at a secured service, such as a mobile telecommunication network, based on respective security credentials.

For example, the application program dataset may be selected for at least temporarily carrying out authentication commandos received from the server device. After the security credentials have been then set through API, a reboot of the secure element may be performed. After the reboot, the operating system of the secure element may access and utilize the security credentials.

The application program dataset may at least in part be provided on the secure element and can be configured to interact with the user device and/or at least one network terminal thereof. In other words, the application program dataset may at least partly run on the secure element, for example, in the form of an applet, such as a Java Card applet and/or Ultralight Bootstrap (ULB) applet. The API can be provided in the form of a Java Card API, or alike.

Furthermore, the application program dataset may be provided as a part of an operating system dataset of the secure element and/or may be configured to interact with the operating system dataset. A complete operating system dataset and/or subsets thereof may comprise the application program dataset. The operating system dataset and/or application program dataset may be configured to read, write, delete, manage and/or administer any kind of data stored on the secure element and such are the user device. Data objects can be and/or comprise any kind of data element or constructs of data, including, but not limited to data gateways, data accesses, data streams, data blocks, data files, or alike, such as binaries, sounds, images, videos, text, emails, documents, images, folders, etc. The expression “dataset” can be understood as any kind of data composition, such as a file, including source code, object code, or binaries, which may have or fulfil a certain technical function.

Additionally, an installation program dataset can be provided for installing and/or managing the application program dataset, such as for installing and/or updating an operating system dataset or respective update data subsets, including the application program dataset. Both, the installation program dataset and the installation program dataset may be integrated as data subsets into a customization dataset, such as a firmware suite allowing for customization of data on the secure element as described herein.

The present disclosure allows for granting access to secure information contained within the security credentials without the need to disclose information regarding respective data structures thereof, such as sharing file IDs, definitions, and/or structures, thereby shielding these data structures from unwanted and/or an authorised access. The application program dataset and/or API can be provided by a single trusted entity which can share the application program dataset and/or API for usage by other parties involved, including third parties (e.g., competitors, suppliers, partners, or alike, in particular when serving a common customer) without sharing its security own credentials, instead allowing third party to attach their security credentials to the shared application program dataset and/or API. This can help to simplify managing only one single source code stream and/or product, thereby facilitating maintenance and at the same time increasing reliability.

According to an embodiment of the method, the application program dataset is configured to call the API. The API may then carry out functions and/or deliver information to the operating system dataset, as called by the application program dataset. This further helps in shielding restricted data structures from unwanted and/or an authorized access, yet, enabling the utilization of information contained therein.

According to an embodiment of the method, the application program dataset and/or the API are configured to be controlled by command messages. The command messages can be exchanged between the application program dataset and the API. This further helps in enhancing and facilitating communication between the application program dataset and the API.

According to an embodiment of the method, the security credentials are embedded in data objects and the API is configured to access the data objects. The data objects and respective data structures can be defined by a single trusted entity. This may further help in shielding restricted data objects and related data structures from unwanted and/or an authorized access, yet, enabling the utilization.

According to an embodiment of the method, the security credentials are at least in part provided in the form of at least one elementary file and/or within a secure memory location within secure element, and the API is configured to create, alter, update, and/or access the elementary file and/or a secure storage location within secure element, in particular used to store security credentials, such as security keys. Such elementary files and/or secure memory locations maybe used according to standardised file structures, such as the ETSI TS 102 221 file structure of UICC application (chapter 8.1, FIG. 8.1) and/or any proprietary EUM file structure. Thereby, the application program dataset can, instead of directly calling the EFs and/or directly accessing storage locations with credentials (NAA keys, Opc, K, Milenage constants), call the API. This further helps in shielding restricted data structures, in particular elementary files and/or secure memory locations, from unwanted and/or an authorized access, yet, enabling the utilization of information contained therein.

According to an embodiment of the method, the application program dataset is configured to access, alter, update, and/or create at least one application dedicated file and/or dedicated file enabling access to the information provided in the security credentials. The application dedicated file and/or dedicated file maybe used according to standardised file structures, such as the ETSI TS 102 221 file structure of UICC application (chapter 8.1, FIG. 8.1). This additionally helps in shielding restricted data structures, in particular elementary files, from unwanted and/or an authorized access, yet, enabling the utilization of information contained therein.

According to an embodiment of the method, the API is configured to allow the application program dataset to steer a selection of at least one application dedicated file and/or dedicated file through the API enabling access to the information provided in the security credentials. The application dedicated file can provide an entry point to an application. The API can provide a pointer to respective information contained in the application dedicated file and/or dedicated file. This can further help in shielding restricted data structures, in particular elementary files, from unwanted and/or an authorized access, yet, enabling the utilization of information contained therein.

According to an embodiment of the method, at least two sets of security credentials are provided. The API can help to select information from the at least two sets of security credentials. Each of the at least two sets of security credentials may be provided for enabling a user to access a particular secured service, such as different mobile telecommunication networks, or alike. This further helps in providing a way to securely handle security credentials for user devices involving their secure elements, such that on the one hand, convenient operation and availability, as well as on the other hand, functional safety, and multiple secured services, such as different network attachments can be assured or at least improved in a satisfactory manner.

According to an embodiment of the method, the security credentials are provided by at least two different trusted entities. For example, the different trusted entities may each act as credential providers may provide two different sets of security credentials. The API can call the different sets of security credentials for different credential providers which may all be using the same application program dataset. This can additionally help in providing a way to securely handle security credentials for user devices involving their secure elements, such that on the one hand, convenient operation and availability, as well as on the other hand, functional safety, and multiple secured services, such as different network attachments can be assured or at least improved in a satisfactory manner.

According to an embodiment of the method, the at least one user profile dataset for a user is being accessed, altered, updated, and/or created at least in part based on the security credentials. The user profile dataset can include at least a part of the security credentials. Therefore, the at least one user profile dataset can comprise respective diversified data configured for accessing the at least one mobile telecommunication network the at least one user profile dataset can include security credentials configured for accessing at least one mobile telecommunication network and the at least one further mobile telecommunication network. The security credentials may be administered by the server device and/or trusted entity.

The security credentials may be configured such that outside of a manufacturing environment and/or in a post-issuance state they can be accessed via the application program dataset. The security credentials can be provided as a set of security credentials based on respective requirements of the secured services, such as mobile telecommunication networks to be accessed. This further helps in providing way to handle different network attachments of user devices involving their secure elements, such that on the one hand, convenient operation and availability, as well as on the other hand, functional safety, and security of can be assured or at least improved in a satisfactory manner.

The security credentials and/or user profile dataset may comprise respective diversified data configured for accessing at least one secured service, such as a mobile telecommunication network. The diversified data may comprise at least one profile identifier, subscription identifier, authentication certificate, cryptographic parameter, and/or security key configured for accessing the secured service. Furthermore, the diversified data may comprise the security credentials and/or may underlie the security credentials. This can further help in providing way to handle different security credentials of user devices involving their secure elements, such that on the one hand, convenient operation and availability, as well as on the other hand, functional safety, and security of can be assured or at least improved in a satisfactory manner.

### BRIEF DESCRIPTION OF THE DRAWINGS

FIG. 1 is a schematic exemplary illustration of a communication system configured for carrying out a method according to the present disclosure.

FIG. 2 is a schematic exemplary illustration of a file system that can be used for managing data objects involved in carrying out a corresponding method.

### DETAILED DESCRIPTION

The following detailed description is merely exemplary in nature and is not intended to limit the invention and uses of the invention. Furthermore, there is no intention to be bound by the preceding background or the following detailed description. The representations and illustrations in the drawings are schematic and not to scale. Like numerals denote like elements. A greater understanding of the described subject matter may be obtained through a review of the illustrations together with a review of the detailed description that follows.

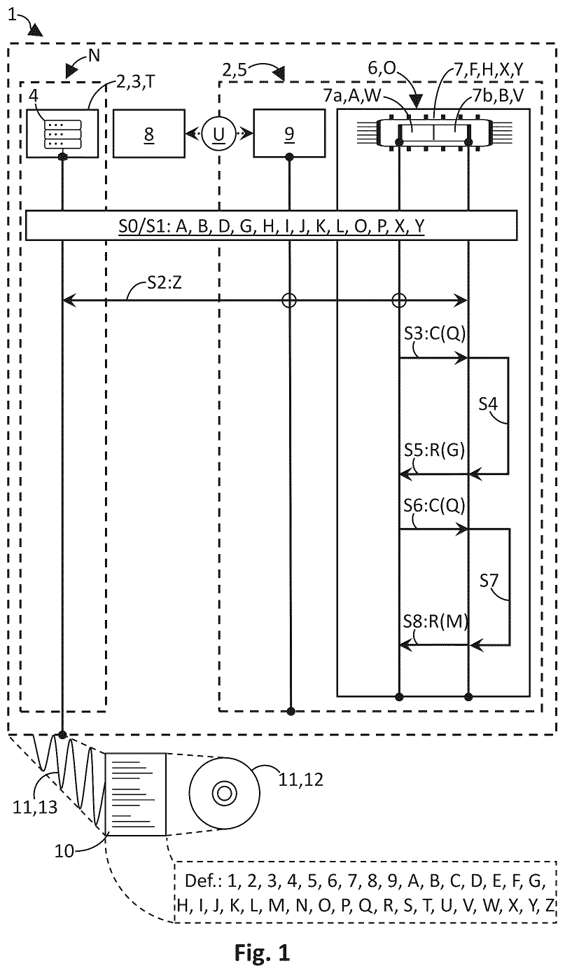

FIG. 1 shows an schematic illustration of an example of a communication system 1 comprising a computing device 2, for instance, in the form of a server device 3 controlled by a trusted entity T, which can include a hardware security module 4 adapted to store, manage and/or provide application program dataset A, operating system datasets O and/or user profiles P for configuring a further computing device 2, for example, in the form of a user device 5 which may be embodied an Internet of Things (IoT) device, such as a multimedia device, camera, speaker, household appliance, measurement device, industrial installation, vehicle, vending machine, or alike, to be associated with a machine entity, and/or as a smart card, an identification card, a transaction card, a personal mobile device, such as a smartphone, smartwatch, etc., to be associated with a personal entity. For example, the server device 3 may be provided in the form of a Server for Subscription Manager Data Preparation+ (SM-DP+).

In the present example, the user devices 5 may be adapted for secure operation, transactions and/or communication, e.g., accessing a secure service, such as a mobile telecommunication network N by means of at least one user profile dataset P to be saved in a respective secure element 6 or tamper resistant element (TRE), such as an UICC, eUICC, iUICC, SIM, eSIM, iSIM, SE, eSE, or alike, provided in the form of a computer chip. The user profile data sets P are generated based on respective personal records contained in data files on the server device 3, in particular, the hardware security module 4 thereof. For storing and managing user profile data sets P on the secure elements 6, an operating system dataset O is installed on the secure element 6, for example, in a secure storage location 7, such as an Issuer Security Domain-Root (ISD-R) provided on the secure element 6. The secure storage location 7 may provide different memory regions, such as at least one first memory region 7a and at least one second memory region 7b.

At least one user profile dataset P stored in the secure element 6 can be associated to a respective user U and can therefore be configured according to respective diversified data L and/or to access at least one data object D. The at least one user profile P, diversified data L, and/or data object D can have a predefined data format as required for accessing the mobile telecommunication networks N, and can be stored in respective memory regions 7a, 7b of the secure storage location 7. By accessing the telecommunication network N, the user may be provided with respective network services and access to data objects D. For example, the mobile telecommunication network N may be a public network (PN), a non-public network (NPN), such as a private network provided by a certain government, or non-government institution, e.g., schools, colleges, government agencies, departments, universities, or alike, and/by or private companies, such as service providers, etc.

A management application 8 may be provided which can be configured to allow the user U to communicate with the user device 5, in particular the secure element 6, for example, directly and/or through a communication interface 9 to the user device 5. The management application 8 can be provided in the form of a remote manager, such as an eSIM IoT remote manager (eIM) which may be securely identified by means of an application identifier and/or authenticated by means of an authentication certificate. The communication interface 9 may be provided in the form of a logical end-to-end interface (ESep) enabling secure communications between the management application 8 and the secure element 6, which can be used to transfer data packages, such as eUICC Packages, for instance to carry out Profile State Management and eIM configuration tasks by means of the eIM. For example, the communication interface 9 may be provided as a part of a local management application, such as a IoT Profile Assistant (IPA), which may take the form of an IoT Profile Assistant (IPAd) provided to the user device 5, and/or an IoT Profile Assistant provided (IPAe) arranged in the secure element 6. Alternatively, or additionally, the management application 8 and/or communication interface 9 may be provided as a local profile assistant (LPA) provided to the user device 5 and/or arranged in the secure element 6.

The operating system dataset O may comprise and/or may be configured to interact with an application program dataset A, the at least one user profile P and/or security credentials H, including profile identifiers I, authentication certificates J, security keys K, including network authentication keys (NAA), and/or or cryptographic parameters M, such as Milenage Constants, TUAK Algo-Code, etc. The security credentials H may comprise any kind of credentials defined by e.g., the GSMA, or alike. The security keys K may comprise any kind of cryptographic code or key element which may be adapted to interact with the user devices 5, the secure elements 6, and/or the server device 3 of the trusted entity T as an issuer of any part of the application program dataset A, the security credentials H, the diversified data L, the at least one user profile P, the operating system dataset O, the profile identifiers I, and/or the authentication certificates J and/or any component thereof. The authentication certificates J may be any kind of electronic certificate, for example, that can be issued by the trusted entity T, for authenticating an origin of the user devices 5, the secure elements 6, the secure storage location 7, the application program dataset A, the security credentials H, the diversified data L, the operating system dataset O, the at least one user profile P, the profile identifiers I, and/or any component thereof.

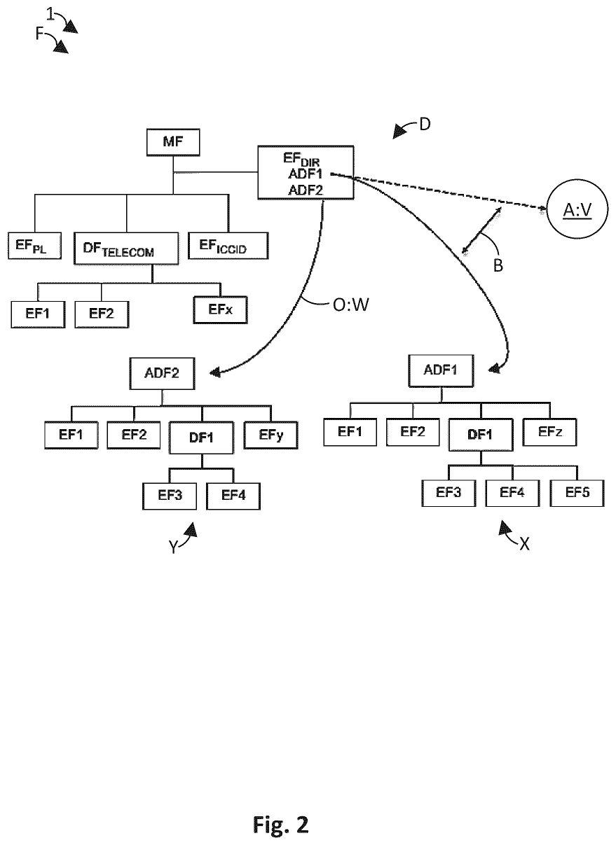

The application program dataset A is configured to communicate with an application programming interface (API) B, for example, by means of command messages C. In the present example, the application program dataset A and the API B are provided on the secure element 6. The application program dataset A can send a call Q or query to the API B for retrieving, accessing and/or altering information in the security credentials H, for example, in the form of a credential value G. The credential value G can underlie or at least be a part of the security credentials H which may be provided as different sets X, Y of security credentials H arranged in a respective file system F (see FIG. 2)

In any of the embodiments of the communication system 1 as described herein, in particular the computing devices 2, can be configured to execute a computer program in the form of a configuration program 10. A computer-readable data carrier 11 can have stored thereon the configuration program 10 and may take the form of a computer-readable medium 12 and/or data carrier signal 13. When carrying out the configuration program 10, the security system 1 and any components thereof communicate as specified in the configuration program 10. Parameters associated with and/or underlying the security system 1, any of the components thereof and/or any steps S carried out thereby, can be defined in and/or by the configuration program 10.

For carrying out the steps S, the configuration program 10 may provide and/or define respective command messages C, which can be configured to interact with the user devices 5, the secure elements 6, the secure storage location 7, the application program dataset A, the API B, the security credentials H, the diversified data L, the operating system dataset O, the at least one user profile P, the profile identifiers I, the mobile telecommunication network N and/or any component thereof. Transmission lines (not shown) may be provided for handling and/or transferring any of the above data components and/or data objects D, for example, via the mobile telecommunication network N, parts thereof and/or elements connected thereto. The mobile telecommunication network N may comprise any kind of wired and/or wireless transmission and/or broadcasting chains or lines, including the Internet (for transmissions “Over-The-Air”) as well as other physical and/or non-physical data carriers, which can be configured and secured as desired and required by the communication system 1 and its components.

In a first step S1, the server device 3 may provide any of the data components of the configuration system 1, including the operating system dataset O, possibly along with the application program dataset A, API B, credential values G, security credentials H, diversified data L and/or at least one user profile P associated with the user U, to the secure element 6 of the user device 5, for example through the communication interface 9 to be stored in the secure storage location 7 for deployment to the user U. The at least one user profile P may be created based upon the diversified data L. In particular, certain security credentials H may have a high or even the highest security level conceivable for the secure element 6. Therefore, such security credentials H can be provided on a proprietary file format defined by a respective trusted entity T providing the security credentials H. Any of the mentioned data components may be provided as an/or enable access data objects D, such as electronic load files (ELF), data blobs, or alike.

In the present example, the data provision and step S1 can be associated with a pre-issuance condition of the user device 5 and/or the secure element 6. Any of the steps taking place after the activation process in a step S2 can be associated with a post-issuance condition of the user device 5 and/or the secure element 6, for example, involving a respective registration confirmation Z. Providing operating system dataset O, possibly along with the application program dataset A, API B, credential values G, security credentials H, diversified data L and/or at least one user profile P to the user device 5 and/or the secure element 6 can therefore be regarded as a zeroth step S0 which may take place in a factory and/or manufacturing facility before the first step S1 of providing data to the user device 5 and/or the secure element 6.

In a third step S3, the communication interface 9, for example, of a modem or network terminal (not shown) of the user device 5, may demand a certain operation involving a security credential H. The application program dataset A, for example, provided in the form of an applet running as a part of an/or along with the operating system O providing an operating instance W in the first memory region 7a of the secure storage location 7, can send a command message C with a respective call Q or query to the API B, which may provide a virtual instance V or applet instance that can be provided and the second memory region 7b of the secure storage location 7. For example, in order to select a certain application dedicated file ADF (see FIG. 2), the command message C with its respective call Q (in parenthesis) may take the following form:
switchADF_USIM_AID(boolean ulbInstance)

In a fourth step S4, based on whether the virtual instance V is available, it can be selected. In the present example, if the call Q ulbInstance=true, when terminal selects ADFUSIM, the virtual instance V, such as an ULB applet instance, will be selected. If the call Q ulbInstance=false, when the terminal selects ADFUSIM, the “real” ADFUSIM will be selected. In a fifth step S5, the API B can return respective response R, possibly containing the respect received credential value G, to the application program dataset A to be further processed, for example, being forwarded via the remote management application 8 asset or communication interface 9.

Using command messages C, for example in the form of the commands as described above with the help of the application program dataset A that can query the API B, can help to determine whether a specific security credential H is available and based in the results take the decision to perform a respective action. As another example, in a sixth step S6, the application program dataset A can send a further command message C with respective call Q or query to the API B. For example, in order to retrieve a specific credential value G from the security credentials H, such as a cryptographic parameter M, e.g., Milenage Constants, the command message C with its respective call Q (in parenthesis) may take the following form:
setMilenageCredentials (byte [ ] Ki,short KiOffset, byte [ ] OPc, short OPcOffset,short refMilenageConstants)

In a seventh step S7, according to the present example, set Ki, OPc can be stored in secure non-volatile (NV) memory and refMilenageConstants to identify cryptographic parameters M in the form of Milenage Constants for authentication. In an eights step S8, a respective response R, for example, containing the cryptographic parameter M, can be returned from the API B to the application program dataset A. In the present example, the application program dataset A, for instance a ULB applet, can set the refMilenageConstants value to 0 by default. If the application program dataset A finds a match of the Temp-IMSI in the (ULB proprietary) EF_IMSI_MATCHING_TABLE, it can use the AuthConst Id (of the matching entry) as the value for this parameter. Instead of a short value for the refMilenageConstants, also a byte value could be used (if we restrict the allowed AuthConst ID range, e.g. 0x0001<AuthConst ID<0x007F).

FIG. 2 shows a schematic exemplary illustration of a filesystem F that can be used for managing data objects D, for example, in the form of application dedicated files, dedicated files DF, elementary files EF, and/or master files MF as defined by of ETSI TS 102 221 which may be involved in carrying out a corresponding method. According to the present example, the secure element 6, such as an UICC may have two USIM ADFs, namely ADF1 and ADF2, along with a respective directory file EF_DIR. The application program dataset A, for example, again a ULB applet, can be enabled to replace ADFUSIM AID in EFDIR with its own instance AID in order to be selected by the terminal instead of the “real” ADFUSIM. In the same or at least similar way, the application program dataset A can be enabled to restore the real ADFUSIM AID in the directory file EF_DIR.

According to the present example, the application program dataset a can update a proprietary EFDIR (under the proprietary file ID-FID). The proprietary EFDIR can have the same FID as the standard file directory EFDIR (under the master file MF) and both files are linked to each other. The API B can allow the application program dataset A to steer the selection of ADFUSIM by with the same effect as when selecting proprietary files, but in a different way, e.g. by using a command message C in the following form with a respective call Q query similarly to already mentioned above:
ULB_API.switchADF_USIM_AID(boolean ulbInstance)
ulbInstance=true: when terminal selects ADFUSIM, the ULB applet instance will be selected
ulbInstance=false: when terminal selects ADFUSIM, the “real” ADFUSIM will be selected

Additionally, systems and methods may be configured to call the API B. This may need respective adaptation of the code underlying the application program dataset. In the example shown in FIG. 2 based on the ETSI TS 102 221, the application program dataset A influences the selection of ADFUSIM by means of the API B. Therefore, the application program dataset A can be enabled to update certain data objects D, such as an elementary file EF containing a profile identifier I, for example, an International Mobile Subscriber Identity (IMSI) which can be stored in the respective identity elementary file EF_IMSI.

According to the present example, the application program dataset A can update any proprietary EF_IMSI (under the respective proprietary FID). The proprietary EF_IMSI can have the same FID as the standard EF_IMSI (under ADFUSIM) and both files are linked to each other. The application program dataset A can be enabled to set Ki, OPc and the Milenage Constants to be used for the network authentication. This can be achieved by the API B, e.g., with the following command messages C and respective calls Q or queries:
ULB_API.setMilenageCredentials (byte [ ] Ki, short KiOffset, byte [ ] OPc, short OpcOffset short refMilenageConstants),
wherein Ki: byte array containing the (16 byte long) Ki; KiOffset: offset in Ki, where Ki is stored; OPc: byte array containing the (16 byte long) OPc; OPcOffset: offset in OPc, where OPc is stored; refMilenageConstants: reference to standard/default or IMSI specific Milenage Constants;
refMilenageConstants=0: default/standard Milenage Constants;
refMilenageConstants>0: (Temp-) IMSI specific Milenage Constants.

For example, as a response R to the command message C “setMilenageCredentials” the API B can return 0x00 upon success and OXFF—as generic Error. More Error codes can be provided in future to address specific error handling by the application program dataset A. The application program dataset A can set a respective credential value G, for example the cryptographic parameter M, such as the refMilenageConstants value, to 0 by default. If the application program dataset A finds a match of the Temp-IMSI in the respective matching table (not shown), such as the (ULB proprietary) EF_IMSI_MATCHING_TABLE, the application program dataset A can use the AuthConst Id (of the matching entry) as the value for this parameter. Instead of a short value for the refMilenageConstants, also a byte value could be used (for example, involving a restriction the allowed AuthConst Id range, e.g. 0x0001<AuthConst Id<0x007F).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those of ordinary skill in the art with a convenient road map for implementing an exemplary embodiment of the invention. It will be understood that various changes may be made in the function and arrangement of elements described in an exemplary embodiment without departing from the scope of the claims.

As an example, the present disclosure with its disclosed configurations provides a way to securely handle security credentials for user devices involving their secure elements, such that on the one hand, convenient operation and availability, as well as on the other hand, functional safety, and security of different network attachments can be assured or at least improved in a satisfactory manner. In turn, this allows to enhance and facilitate an integration of secure operations across multiple parties involved, for example, users and providers of secure elements, including secure element manufacturers, such as different eUICC manufacturers (EUM). By eliminating a need to share certain classified information regarding respective data structures, any documentation shared amongst the parties, including third parties, involved can be restricted to a degree that it allows them to share operation of the application program dataset and/or API.

Further developments can be derived from the dependent claims and from the following description. Features described with reference to a user device, secure element, server device and components thereof may be implemented as method steps, or vice versa. Therefore, the description provided in the context of the user device, secure element, server device and their components analogously applies to respective methods. In particular, features and functions of the user device, secure element, server device and their components may be implemented as method steps which in turn may be implemented as respective device features or functions.

Additionally, it is noted that “comprising” or “including” does not exclude any other elements or steps and “a” or “an” does not exclude a multitude or plurality. It is further noted that features or steps which are described with reference to one of the above exemplary embodiments may also be used in combination with other features or steps of other exemplary embodiments described above. Reference signs in the claims are not to be construed as a limitation.

It is claimed:

1. A method of configuring a user device to enable a user to access to a secured service for communication via at least one mobile telecommunication network, said method comprising:
providing security credentials, by a trusted entity, adapted to allow a secure element of the user device to enable access to a secured service of at least one mobile telecommunication network;
storing the security credentials in the secure element; and
providing an application program dataset configured to at least partly access and alter information provided in the security credentials via an application programming interface (API).

2. The method of claim 1, wherein the application program dataset is configured to call the API.

3. The method of claim 2, wherein the application program dataset and the API are configured to be controlled by command messages.

4. The method of claim 3, wherein the security credentials are embedded in data objects and the API is configured to access the data objects.

5. The method of claim 4, wherein the security credentials are at least in part provided in the form of at least one elementary file and within a secure storage location within the secure element, wherein the API is configured to create, alter, update and access the elementary file and the secure storage location for storing the security credentials.

6. The method of claim 5, wherein the application program dataset is configured to access, alter, update, and create at least one application dedicated file and dedicated file enabling access to the information provided in the security credentials.

7. The method of claim 6, wherein the API is configured to allow the application program dataset to steer a selection of at least one application dedicated file and dedicated file through the API enabling access to the information provided in the security credentials.

8. The method of claim 7, wherein at least two sets of security credentials are provided.

9. The method of claim 8, wherein the security credentials are provided by at least two different trusted entities.

10. The method of claim 9, wherein at least one user profile dataset for a user is being accessed, altered, updated, and created at least in part based on the security credentials.

11. The method of claim 1, wherein a configuration program configures a user device to enable a user to access the secured service.

12. The method of claim 11, wherein the application program dataset operates a secure element of a user device, wherein the secure element includes an eUICC.

13. The method of claim 12, wherein a non-transitory computer-readable medium has stored thereon the configuration program and the application program dataset.

14. The method of claim 13, wherein a user device is configured to enable a user to access to the secured service.

15. The method of claim 14, wherein a server device provides a secure location for handling the security credentials.
